(19) United States
(12) Patent Application Publication
(10) Pub. No.: US 2024/0281717 A1
(43) Pub. Date: Aug. 22, 2024

(54) Method and Apparatus for Training a Model

(71) Applicant: Siemens Aktiengesellschaft, München (DE)

(72) Inventors: Qi Tang, Changshu (CN); Wen Chao Wu, Shanghai (CN); Cong Chao Li, Suzhou (CN); Fan Wang, Beijing (CN); Jia Wen Chen, Suzhou (CN)

(73) Assignee: Siemens Aktiengesellschaft, München (DE)

(21) Appl. No.: 18/681,193

(22) PCT Filed: Aug. 11, 2021
(86) PCT No.: PCT/CN2021/112053

§ 371 Date: Feb. 5, 2024

(51) Int. Cl. G06N 20/00

(52) U.S. Cl. CPC G06N 20/00

(57) ABSTRACT

Various embodiments of the teachings herein include a method for training a model configured to monitor a working status of equipment based on sensor data. An example method includes: training a model using a training data set including historical sensor data gathered only when the equipment is under normal working conditions; testing the model with sensor data causing a false alarm, sensor data of the equipment's historical confirmed failure, and sensor data within pre-defined recent time period when the equipment is under normal working conditions; and activating the model if the model passes test, otherwise rejecting the model.

### CROSS-REFERENCE TO RELATED APPLICATIONS

This application is a U.S. National Stage Application of International Application No. PCT/CN2021/112053 filed Aug. 11, 2021, which designates the United States of America, the contents of which are hereby incorporated by reference in their entirety.

### TECHNICAL FIELD

The present disclosure relates to equipment status monitoring/Various embodiments of the teachings herein include methods, apparatus, and/or computer-readable storage medium for training a model for monitoring working status of an equipment.

### BACKGROUND

The increasing number of sensors set up in production plants makes it possible to collect sensor data for monitoring working status of an equipment, detecting anomalies, and predict failures. There are many machine learning approaches trying to realize the equipment working status monitoring (e.g. failure type detection and predictive maintenance). Machine learning approaches have ability to handle high dimensional and multivariate data, extract hidden relationships within data in complex and dynamic environments.

However, the deployed models typically lack the ability to continuously monitor targeted equipment, which means the predictive maintenance solution itself relies on the periodical maintenance on models due to temporal, manufacturing, loading, ambient or other factors. One possible reason is that the equipment working conditions are various and volatile, while the deployed solution is relatively static and requires heavy input to update models (e.g. manually label and update training samples).

### SUMMARY

Teachings of the present disclosure include model self-updating solutions, with which status monitoring can be based on continuously updated model and can be applicable in various and volatile working conditions. For example, some embodiments of the teachings herein include a method for training a model is presented, wherein the model is configured to monitor working status of an equipment based on sensor data, and the method can includes: training a model based on a training data set only including historical sensor data when the equipment is under normal working condition; testing the model with sensor data causing false alarm, sensor data of the equipment's historical confirmed failure and sensor data within pre-defined recent time period when the equipment is under normal working condition; and activating the model if the model passes the test.

As another example, some embodiments include an apparatus for training a model includes modules to execute one or more of the methods described herein.

As another example, some embodiments include an apparatus for training a model including at least one processor; and at least one memory, coupled to the at least one processor, configured to execute one or more of the methods described herein.

As another example, some embodiments include a computer-readable medium storing computer-executable instructions, wherein the computer-executable instructions when executed cause at least one processor to execute one or more of the methods described herein.

### BRIEF DESCRIPTION OF THE DRAWINGS

The above-mentioned attributes and other features and advantages of the present technique and the manner of attaining them will become more apparent and the present technique itself will be better understood by reference to the following description of example embodiments of the teachings of the present disclosure taken in conjunction with the accompanying drawings, wherein:

FIG. 1 depicts a block diagram of an apparatus for training a model incorporating teachings of the present disclosure;

FIG. 2 depicts different normal working conditions;

FIG. 3 depicts a flow diagram of a method for training a model incorporating teachings of the present disclosure; and

FIG. 4 depicts a flow diagram of sub step S3021.

### REFERENCE NUMBERS

10, an apparatus for training a model
101, at least one processor
102, at least one memory
103, a communication module
20, a model training program
201, training module
202, testing module
203, monitoring module
204, failure detection module
21, training data set only including historical sensor data when
the equipment is under normal working condition
22, sensor data causing false alarm
23, sensor data of the equipment's historical confirmed failure
24, sensor data within pre-defined recent time period when the
equipment is under normal working condition
25, sensitivity
26, specificity
27, real-time sensor data
28, model
300, a method for training a model
S301˜S309, steps of method 300
S3021a˜S3021b, sub steps of S3021

### DETAILED DESCRIPTION

By only using sensor data collected when the equipment is under normal working condition, the sensitivity of the model can be improved to detect all possible anomalies. Use of sensor data to test a candidate model's performance includes typical events under normal and abnormal working conditions. By passing a test, validity of activated model can be ensured.

Before activating a candidate model to a ready-to-use one, the model can be tested, which can help to find the best model that represents current input sensor data and how well the model will work in the future. Furthermore, the sensor data used for testing includes sensor data causing false alarms, sensor data of the equipment's historical confirmed failure, and sensor data within pre-defined recent time period when the equipment is under normal working condition. With both confirmed failure sensor data, normal working condition sensor data and false alarm sensor data, the candidate model can be tested from both sides, and also with recent normal sensor data for testing, the recent change of normal working conditions can be tracked and updated, which makes the tested model an updated one.

In some embodiments, when testing the model, sensitivity of the model can be calculated based on the sensor data of the equipment's historical confirmed failure, and specificity of the model can be calculated based on the sensor data causing false alarm and the sensor data within pre-defined recent time period when the equipment is under normal working condition. If the sensitivity is not lower than a first predefined threshold and the specificity is not lower than a second predefined threshold, it can be determined that the model passes test. With predefined sensitivity and specificity thresholds, the test results can be controlled flexibly according to different application scenarios. Given that the candidate model should predict early warnings, taking into account that predicted alarm time of each event had better be earlier than that of the true alarm point, the specificity is calculated based on the sensor data causing false alarm and the sensor data within pre-defined recent time period when the equipment is under normal working condition.

In some embodiments, real-time sensor data can be collected, and working condition of the equipment can be monitored by inputting the real-time sensor data into the activated model. If no alarm is generated, the real-time sensor data will be taken as the sensor data within predefined recent time period when the equipment is under normal working condition, and if an alarm is generated, failure pattern recognition can be conducted and if a failure is not recognized, the real-time sensor data can be taken as the sensor data causing false alarm. With the real-time sensor data monitoring the working condition, new false alarm sensor data and new normal sensor data can be further collected and be used for updating and testing the candidate model.

Furthermore, if a failure is recognized, the real-time sensor data, sensor data from a first pre-defined previous time point to the start time point of the real-time sensor data, and sensor data from a second pre-defined later time point to the end point of the real-time sensor data together can be taken as the sensor data of the equipment's historical confirmed failure.

Hereinafter, above-mentioned and other features of the present technique are described in detail. Various embodiments are described with reference to the drawings, where like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of the disclosure. It may be evident that such embodiments may be practiced without these specific details.

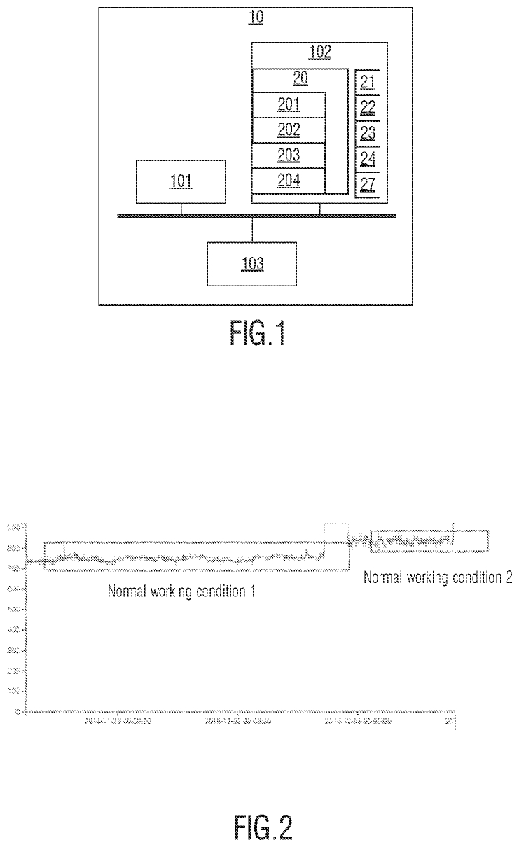

When introducing elements of various embodiments of the present disclosure, the articles “a”, “an”, “the” and “said” are intended to mean that there are one or more of the elements. The terms “comprising”, “including” and “having” are intended to be inclusive and mean that there may be additional elements other than the listed elements. Now the present disclosure will be described hereinafter in details by referring to FIG. 1 to FIG. 4.

FIG. 1 depicts a block diagram of an apparatus for training a model incorporating teachings of the present disclosure. The apparatus 10 for training a model presented in the present disclosure can be implemented as a network of computer processors, to execute following method 300 for training a model presented in the present disclosure. The apparatus 10 can also be a single computer, as shown in FIG. 1, including at least one memory 102, which includes computer-readable medium, such as a random access memory (RAM). The apparatus 10 also includes at least one processor 101, coupled with the at least one memory 102. Computer-executable instructions are stored in the at least one memory 102, and when executed by the at least one processor 101, can cause the at least one processor 101 to perform the steps described herein.

The at least one processor 101 may include a microprocessor, an application specific integrated circuit (ASIC), a digital signal processor (DSP), a central processing unit (CPU), a graphics processing unit (GPU), state machines, etc. embodiments of computer-readable medium include, but not limited to a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable medium may transmit or carry instructions to a computer, including a router, private or public network, or other transmission device or channel, both wired and wireless. The instructions may include code from any computer-programming language, including, for example, C, C++, C#, Visual Basic, Java, and JavaScript.

The at least one memory 102 shown in FIG. 1 can contain a model training program 20, when executed by the at least one processor 101, causing the at least one processor 101 to execute the method 300 for training a model presented in the present disclosure. longitudinal data 31 can also be stored in the at least one memory 102. These data can be received via a communication module 105 of the apparatus 10.

The model training program 20 can include:
a training module 201, configured to train a model 28 based on a training data set 21 only including historical sensor data when the equipment is under normal working condition; and
a testing module 202, configured to: test the model 28 with sensor data causing false alarm 22, sensor data of the equipment's historical confirmed failure 23 and sensor data within pre-defined recent time period when the equipment is under normal working condition 24; and activate the model 28 if the model 28 passes test.

In order to monitor working status of an equipment or a system, various sensors or transduces can be deployed, such as temperature sensors, pressure sensors, humidity sensors, which can collect information related to a targeted equipment. With the sensor data collected, via the model trained based on the sensor data, working status of the targeted equipment can be monitored.

The monitoring can be conducted based on a model, such as a machine learning model (e.g. GMM (Gaussian Mixed Model), isolation forest, etc.). In the training module 201, the training data set 21 are used for training the candidate model 28. Sensor data 21 can be collected via data-collecting sensors deployed on the targeted equipment (e.g. physical product or machine).

In some embodiments, the training data set 21 only includes sensor data when the equipment is under normal working condition under normal working conditions, no sensor data under different failure types are used to train model 28, because sometimes it is not very easy to detect all types of failures, but an anomaly can be discerned. In addition, although failures that occur could be detect and distinguished from one another, however, by the time the failure is detected, it is too late to schedule any maintenance action.

Normal working conditions of a targeted equipment may be various and volatile under different environment factors, as well as different production load. For example, FIG. 2 depicts different normal working conditions, showing data trends of one installed temperature sensor under different normal working period caused by process shifts.

Direct use of such sensor data sets in such circumstances may affect the model 28's performance. For example, in GMM model, the component weight of normal working condition 2 (FIG. 2) might be small, and may generate false alarms in real-time monitoring. So optionally, before sending sensor data 21 to modeling process, sensor data's can validated quality and improved by preprocessing values of sensor data in the training data set 21. For example, by balancing sensor data sets from different normal working conditions.

To further overcome the challenge, the designed self-updating module in this proposed solution will keep collecting the latest data which are predicted as normal working status in real-time monitoring process, and those supplementary data will be auto-classified to corresponding normal working condition class for further learning. In addition, for those confirmed false alarms will be treated as new working condition class and be updated to current monitoring model.

Before activating a candidate model 28 to a ready-to-use one, the model 28 can be tested by testing module 202, which can help to find the best model that represents current input sensor data and how well the model 28 will work in the future. Testing can be based on following 3 kinds of sensor data:
sensor data causing false alarm 22;
sensor data of the equipment's historical confirmed failure 23; and
sensor data within pre-defined recent time period when the equipment is under normal working condition 24.

As to the sensor data 23 (of the equipment's historical confirmed failure), in order to keep the model 28 updated according to newest working condition and based on all kinds of failure situations, sensor data 23 can be updated regularly. They can either be synchronized with historical confirmed failures, or manually simulated by domain experts. Considering that there might be change of data before true alarm point, in order to detect and predict anomalies as early as possible, sensor data before the true alarm point can also be used as sensor data 23; and also sensor data may keep being affected after true alarm point, sensor data after the true alarm point can also be considered as sensor data 23 for a precise trend analysis. That is, sensor data 23 can include:
sensor data at an alarm point;
sensor data from a first pre-defined previous time point to the alarm point (which can be the start time point of the sensor data at the alarm point); and
sensor data from a second pre-defined later time point to the alarm point (which can be the end point of the sensor data at the alarm point).

As to the sensor data 24 (sensor data within pre-defined recent time period when the equipment is under normal working condition), in order to acquire most updated working condition of the targeted equipment, most recent sensor data in normal working conditions can be selected.

In some embodiments, the testing module 202 can be further configured to:
calculate sensitivity 25 of the model 28 based on the sensor data of the equipment's historical confirmed failure 23, and calculating specificity 26 of the model 28 based on the sensor data causing false alarm 22 and the sensor data within pre-defined recent time period when the equipment is under normal working condition 24;
determine the model 28 passes test if the sensitivity 25 is not lower than a first predefined threshold and the specificity 26 is not lower than a second predefined threshold.

As to the sensitivity 25, for typical failure event sensor data sets, the candidate model 28 is expected to provide early warnings on all events, which means the predicted alarm time of each event had better be earlier than that of the true alarm point, which means the sensitivity 25 should be a number closing to 1. Statistically speaking, the sensitivity can be equal to 1. Here the sensitivity can be defined as below:

$$sensitivity = \frac{number of true positives}{number of true positives + number of false negatives}$$

Sensitivity (also called true positive rate, or the recall) can be used to measure the proportion of actual positives (actual failures) that are correctly predicted as such by a candidate model. To pass the test, the above mentioned “first predefined threshold” can be set as a number close or equal to 1. Here, taking 1 as an example for industrial scenario, where there are limited number of failure events especially for stable operating process, and normally it is intolerable for false negatives (failure events incorrectly identified as healthy), considering the loss caused by machine damage and production suspending.

As to the specificity 26, specificity (also called true negative rate) measures the proportion of actual negatives (healthy events) that are correctly predicted as such by a candidate model. To pass the test, the above mentioned “second predefined threshold” can be set as a number close or equal to 1. Here, taking 0.95 as an example, which can indicate that the candidate model 28 is with high robustness. Here, the specificity 26 can be defined as below:

$$specificity = \frac{number of true negatives}{number of true negatives + number of false positives}$$

Finally, the candidate model 28 can be activated as long as it passes the test (that is the above two metrics), otherwise it can be archived.

To be mentioned that the “first predefined threshold” and the “second predefined threshold” can be defined based on application scenarios. For critical industrial process, the first predefined threshold can be set as a relatively high value, such as 100% or 99.5% in case of missing true negatives.

Once the candidate model 28 is activated, real-time monitoring on the targeted equipment can be conducted. In some embodiments, the apparatus 10 can further include: a monitoring module 203 and a failure detection module 204.

The monitoring module can be configured to collect real-time sensor data 27, execute monitoring working condition of the equipment by inputting the real-time sensor data 27 into the activated model 28. If no alarm is generated, the monitoring module 203 can have the real-time sensor data 27 as the sensor data within predefined recent time period when the equipment is under normal working condition 24, which can be used for testing model 28 in future and also can become part of the training data set 21.

The real-time sensor data 27 will be carefully and continuously evaluated, under which two different results are expected, either alarms generated or not. Before, real-time sensor data predicting normal working status will be simply archived and not used. However, in some embodiments of the present disclosure, sensor data 22 and sensor data 24 can be further used for model training and model testing, which can keep model 28 being actively updated.

As mentioned above, normal working conditions are various, and even under one normal status with different time period selected, data pattern (or scale) might show obvious differences. In practical, a group of factors (e.g. environmental, production schedule, etc.) might lead to those differences, for example, the pressure data collected via target sensor may increase slowly when the ambient temperature goes up. Without updating model 28, the predicted sensor data's values may keep approaching threshold, and easily generate false alarms.

If an alarm is generated, the failure detection module 204 can further conduct failure pattern recognition. If a failure is not recognized, the failure detection module 204 can have the real-time sensor data 27 as the sensor data causing false alarm 22, which can be used for testing model 28 in future and also can become part of the training data set 21. The sensor data causing false alarm 22 can be further classified and be labeled as a new normal working condition. Finally, through updating the model 28, false alarms can be expected to be eliminated automatically.

In some embodiments, if a failure is recognized, the failure detection module 204 can be further configured to have together the real-time sensor data 27, sensor data from a first pre-defined previous time point to the start time point of the real-time sensor data, and sensor data from a second pre-defined later time point to the end point of the real-time sensor data as the sensor data of the equipment's historical confirmed failure 23, which can be used for testing model 28 in future.

In some embodiments, in order to improve the accuracy of working status monitoring, the above mentioned model testing based on updated sensor data set can gradually update the model 28 in an automatic way. By actively involving the designed evaluation mechanism, activated model 28's quality can be further ensured. Although training module 201, the testing module 202, the monitoring module 203 and the failure detection module 204 are described above as software modules of the model training program 20. Also, they can be implemented via hardware, such as ASIC chips. They can be integrated into one chip, or separately implemented and electrically connected.

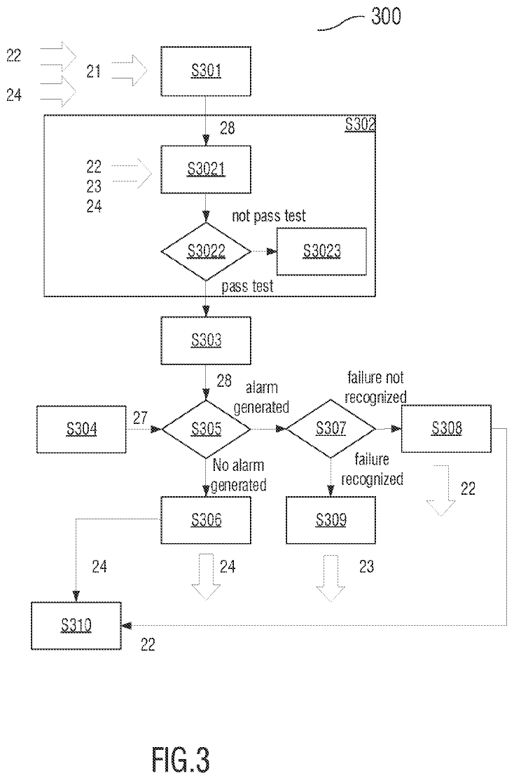

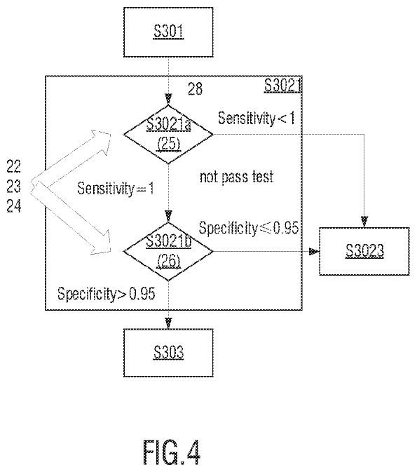

It should be mentioned that the present disclosure may include apparatuses having different architecture than shown in FIG. 1. The architecture above is merely exemplary and used to explain the exemplary method 300 shown in FIG. 3 and FIG. 4.

Various methods in accordance with the present disclosure may be carried out. One exemplary method 300 according to the present disclosure includes:
S301: training a model 28 based on a training data set 21 only including historical sensor data when the equipment is under normal working condition.
S302: testing the model 28 with sensor data causing false alarm 22, sensor data of the equipment's historical confirmed failure 23 and sensor data within pre-defined recent time period when the equipment is under normal working condition 24.

The step S302 testing the model can include following sub steps:
S3021: calculating sensitivity 25 of the model 28 based on the sensor data of the equipment's historical confirmed failure 23, and calculating specificity 26 of the model 28 based on the sensor data causing false alarm 22 and the sensor data within pre-defined recent time period when the equipment is under normal working condition 24;
S3022: determining the model 28 passes test if the sensitivity 25 is not lower than a first predefined threshold and the specificity 26 is not lower than a second predefined threshold.
S303: activating the model 28 if the model 28 passes test.
S304: collecting real time sensor data 27.
S305: executing monitoring working condition of the equipment by inputting the real time sensor data 27 into the activated model 28.
S306: having the real time sensor data 27 as the sensor data within predefined recent time period when the equipment is under normal working condition 24, if no alarm is generated.
S307: conducting failure pattern recognition if an alarm is generated.
S308: having the real time sensor data 27 as the sensor data causing false alarm 22 if a failure is not recognized.
S309: having together the real time sensor data 27, sensor data from a first pre-defined previous time point to the start time point of the real time sensor data, and sensor data from a second pre-defined later time point to the end point of the real time sensor data as the sensor data of the equipment's historical confirmed failure 23, if a failure is recognized.
S310: having the real time sensor data 27 as part of the training data set 21 if no alarm is generated, and having the sensor data causing false alarm 22 as part of the training data set 21.

In some embodiments, a computer-readable medium stores computer-executable instructions, which upon execution by a computer, enables the computer to execute any of the methods presented in this disclosure.

In industry process, predictive maintenance technologies are developed to provide early warnings to target equipment/system failures. However, the real working conditions are complex and changeable, and the deployed monitoring model are expected to be flexible and regularly updated in order to catch those changes. Different from the current predictive solutions, which require additional maintenance input (e.g. IT team/data scientist to maintain the system and manually re-train the model) or complicated and expensive computing resources (e.g. data migration on a cloud-based framework), solutions proposed in the present disclosure can efficiently reduce the maintenance effort and to improve overall usability.

There are several differences between solutions proposed in the present disclosure and known solutions. First of all, solutions proposed in the present disclosure can be implemented as a lightweight one without using GPU or complicated algorithms (e.g. reinforcement learning), the demand of computing resources is limited. Thus, all sensor data as well as the services can be stored and deployed in local place, not stored in cloud, which means the cost of maintaining the solution is less than that of other methods such as edge computing.

Example embodiments of the present disclosure may provide some or all of the following technical advantages:
1) Use of sensor data set to test candidate model's performance, including typical events under normal and abnormal working conditions. By passing test, validity of activated model can be ensured.
2) Further analysis and usage on data that are predicted as normal status: to ensure the deployed model are time sensitive and functionally workable, the historical events under normal status can be used to train the classification model, and any real-time monitored data that predicted as normal status will be classified. Furthermore, the classified data can be used to update the current activated model under pre-set automate task and will be again activated if it successfully passes test.
3) Use of historical alarm events data to realize the failure type detection and false alarm reduction. The stored historical alarm events data are well labeled and trained to build the classification model. When new alarm generates from real-time monitoring model, it will then be classified via built model. The final confirmed true failure will be used to update the failure type classification model, while the false alarm data will be sent to the database that mentioned in above b section as a new normal working condition, and later used to update the real-time monitoring model.)

Use of lightweight machine learning models in solution framework. The proposed solution is flexible and modular in design, the real-time monitoring model are replaceable, and can be selected via models like GMM (Gaussian Mixed Model), and Isolation Forest, compared with deep learning neuro network, those models require less computing resources and more importantly are statistical explainable.

While the present technique has been described in detail with reference to certain embodiments, it should be appreciated that the present technique is not limited to those precise embodiments. Rather, in view of the present disclosure which describes exemplary modes for practicing the teachings, many modifications and variations would present themselves, to those skilled in the art without departing from the scope and spirit of this disclosure. The scope is, therefore, indicated by the following claims rather than by the foregoing description. All changes, modifications, and variations coming within the meaning and range of equivalency of the claims are to be considered within their scope.

What is claimed is:

1. A method for training a model configured to monitor a working status of equipment based on sensor data, the method comprising:
training a model using a training data set including historical sensor data gathered only when the equipment is under normal working conditions;
testing the model with sensor data causing a false alarm, sensor data of the equipment's historical confirmed failure, and sensor data within pre-defined recent time period when the equipment is under normal working conditions; and
activating the model if the model passes test, otherwise rejecting the model.

2. The method according to claim 1, wherein testing the model comprises:
calculating a sensitivity of the model based on the sensor data of the equipment's historical confirmed failure;
calculating a specificity of the model based on the sensor data causing false alarm and the sensor data within pre-defined recent time period when the equipment is under normal working conditions; and
determining the model passes the test if the sensitivity is not lower than a first predefined threshold and the specificity is not lower than a second predefined threshold, else determining the model fails the test.

3. The method according to claim 1, further comprising:
collecting real-time sensor data;
monitoring working condition of the equipment by providing the real-time sensor data into the activated model;
using the real-time sensor data as the sensor data within predefined recent time period when the equipment is under normal working condition, if no alarm is generated;
conducting failure pattern recognition if an alarm is generated; and
using the real-time sensor data as the sensor data causing false alarm if a failure is not recognized.

4. The method according to claim 3, further comprising, if a failure is recognized,
combining the real-time sensor data, sensor data from a first pre-defined previous time point to the start time point of the real-time sensor data, and sensor data from a second pre-defined later time point to the end point of the real-time sensor data as the sensor data of the equipment's historical confirmed failure.

5. The method according to claim 3, further comprising
adding the real-time sensor data to the training data set if no alarm is generated, and including the sensor data causing false alarm as part of the training data set.

6. An apparatus for training a model configured to monitor working status of an equipment based on sensor data, the apparatus comprising:
a training module to train the model using a training data set including historical sensor data collected only when the equipment is under normal working conditions;
a testing module to
test the model with sensor data causing a false alarm, sensor data of the equipment's historical confirmed failure, and sensor data within a pre-defined recent time period when the equipment is under normal working conditions; and
an approval module to activate the model if the model passes the test, else generate a failed test output.

7. The apparatus according to claim 6, wherein the testing module is further configured to:
calculate a sensitivity of the model based on the sensor data of the equipment's historical confirmed failure;
calculate a specificity of the model based on the sensor data causing false alarm and the sensor data within the pre-defined recent time period; and
determine the model passes the test if the sensitivity is not lower than a first predefined threshold and the specificity is not lower than a second predefined threshold.

8. The apparatus according to claim 6, further comprising:
a monitoring module to:
collect real-time sensor data;
execute monitoring working condition of the equipment by providing the real-time sensor data into the activated model;
include the real-time sensor data as the sensor data within predefined recent time period, if no alarm is generated;
a failure detection module to:
conduct failure pattern recognition if an alarm is generated; and
include the real-time sensor data as the sensor data causing false alarm if a failure is not recognized.

9. The apparatus according to claim 8, wherein the failure detection module is further configured to
combine the real-time sensor data, sensor data from a first pre-defined previous time point to the start time point of the real-time sensor data, and sensor data from a second pre-defined later time point to the end point of the real-time sensor data as the sensor data of the equipment's historical confirmed failure, if a failure is recognized.

10. The apparatus according to claim 8, wherein:
the monitoring module is further configured to include the real-time sensor data as part of the training data set if no alarm is generated; and
the failure detection module is further configured to have the sensor data causing false alarm as part of the training data set.

11. An apparatus for training a model, the apparatus comprising:
at least one processor;
at least one memory, coupled to the at least one processor, the at least one memory storing a set of instructions;
wherein the set of instructions, when accessed and executed by the at least one processor, cause the processor to:
train the model using a training data set including historical sensor data gathered only when equipment is under normal working conditions;
test the model with sensor data causing a false alarm, sensor data of the equipment's historical confirmed failure, and sensor data within pre-defined recent time period when the equipment is under normal working conditions; and
activate the model if the model passes test, otherwise rejecting the model.

12. (canceled)
